(19) United States
(12) Patent Application Publication
(10) Pub. No.: US 2026/0291227 A1
(43) Pub. Date: Sep. 24, 2026

(54) METHOD FOR SWITCHING BETWEEN GRID-FOLLOWING AND GRID-FORMING CONTROL MODES OF CONVERTER BASED ON LATCH-LIKE OPERATOR

(71) Applicant: Zhejiang University, Hangzhou City (CN)

(72) Inventors: Yongheng YANG, Hangzhou City (CN); Hao RUAN, Hangzhou City (CN); Yi XIAO, Hangzhou City (CN); Hao LUO, Hangzhou City (CN)

(21) Appl. No.: 19/323,830

(22) Filed: Sep. 9, 2025

(30) Foreign Application Priority Data
Mar. 19, 2025 (CN) 202510324097.X

(51) Int. Cl. H02J 3/001; H02J 3/01; H02J 3/44; H02J 101/22

(52) U.S. Cl. CPC H02J 3/001; H02J 3/01; H02J 3/44; H02J 2101/22

(57) ABSTRACT

The present application relates to the technical field of renewable energy grid connection, and provides a method for switching between grid-following and grid-forming control modes of converters based on a latch-like operator. The method includes the following steps: S1: determining specific control schemes for grid-forming control and grid-following control that are intended to achieve mode switching; S2: separating a synchronization loop and other loops for both the grid-forming control and the grid-following control; S3: modifying the synchronization loop according to a proposed method, and modifying the other loops into a latch-like operator structure; and S4: enabling, by a system with a seamless switching capability between the grid-following control and the grid-forming control, flexible switching between a grid-following operation state and a grid-forming operation state as required.

### CROSS REFERENCE TO RELATED APPLICATION

This application claims the benefit of and priority to Chinese Patent Application No. 202510324097.X, filed March 19, 2025, which is hereby incorporated by reference herein in its entirety.

### TECHNICAL FIELD

The present disclosure relates to the technical field of renewable energy power generation grid connection, and in particular to a method for switching between grid-following and grid-forming control modes of converters based on a latch-like operator.

### BACKGROUND

At present, to address energy and environmental challenges, renewable energy generation systems, including photovoltaic and wind power, are developing rapidly. However, the gradual displacement of synchronous generators by grid-following converters in modern power systems has substantially reduced grid inertia and compromised stability. Consequently, advanced control strategies must be implemented to enhance the stability of grid-connected converters, enabling them to provide essential grid support functions. Such control methodologies are classified as grid-forming control.

Research has shown that grid-following converters and grid-forming converters exhibit duality characteristics. For example, grid-following converters are more stable under strong grid conditions, while grid-forming converters perform better under weak grid conditions. Consequently, implementing adaptive control mode switching between grid-following and grid-forming operations becomes imperative to accommodate real-time grid condition variations. This approach holds significant practical value in improving the penetration rate of renewable energy sources, enabling large-scale grid connection of renewable energy systems, facilitating their role as the primary power supply, and alleviating the global energy shortage crisis.

Currently, many switching solutions between grid-following and grid-forming rely on the identical control loop design, typically requiring current control loops for both grid-following control and grid-forming control. However, with deeper research, various single-voltage-loop grid-forming control methods have been proposed due to better voltage-source characteristics and faster current response, yet no switching method between grid-following and grid-forming control without identical loops has been proposed.

### SUMMARY

The purpose of the present disclosure is to provide a method for switching between grid-following and grid-forming control modes of converters based on a latch-like operator, to resolve the problem of switching between grid-following and grid-forming control modes without an identical control loop.

To achieve the above objective, the present disclosure provides a method for switching between grid-following and grid-forming control modes of converters based on a latch-like operator, including the following steps:

S1: determining specific control schemes for grid-forming control and grid-following control that are intended to achieve mode switching;

S2: separating a synchronization loop and other loops for both the grid-forming control and the grid-following control;

S3: modifying the synchronization loop according to a proposed method, and modifying the other loops into a latch-like operator structure; and

S4: enabling, by a system with a seamless switching capability between the grid-following control and the grid-forming control, flexible switching between a grid-following operation state and a grid-forming operation state as required.

Optionally, in S1, the control schemes for the grid-forming control and the grid-following control are separately determined according to system design requirements, and the proposed method is applicable to various mode switching scenarios between the grid-following control and the grid-forming control, including a case in which no identical control loop exists.

Optionally, in S2, the synchronization loop is defined as a loop for generating a phase of a control coordinate system, and is a phase-locked loop in the grid-following control or a power synchronization loop in the grid-forming control; and the other loops are defined as loops exerting control effects on other variables than the synchronization loop.

Optionally, in S3, for the modification of the other loops, control loops containing integrators are first selected, operating loops of the control loops remain unchanged, and a hot-standby loop is added to pre-synchronize an output value of a controller when an operating mode of the controller is inactive, to achieve subsequent seamless mode switching.

Optionally, in S3, for the modification of the synchronization loop, the primary frequency regulation function of the grid-forming control mode is disabled when the grid-following control mode is enabled, and a phase error feedback loop is added to enable a power synchronization loop of the grid-forming control to track output of a grid-following phase-locked loop without steady-state error in the grid-following operation state.

Optionally, in S4, the system is able to operate in the grid-following operation state or the grid-forming operation state; in the grid-following operation state, all loops of the grid-following control remain active, a grid-forming power synchronization loop disables a primary frequency regulation function and enables a phase error feedback function to track a phase of the grid-following control, the other loops synchronize current variable values through the latch-like operator, for seamless switching to the grid-forming control mode at any time; and in the grid-forming control mode, the grid-forming power synchronization loop disables the phase error feedback function and operates normally, a phase-locked loop of the grid-following control remains operating to track a phase of the grid-forming control without steady-state error, and the other loops synchronize current variable values in real time through the latch-like operator, for seamless switching to the grid-following control mode at any time.

Therefore, the present disclosure employing the method for switching between grid-following and grid-forming control modes of converters based on a latch-like operator demonstrates significant advantages, including:
(1) The method is applicable to achieve the seamless mode switching between grid-following control and grid-forming control without requiring an identical loop. Existing grid-following/grid-forming switching methods require the grid-forming converter to include a current loop to achieve seamless switching, while the present disclosure enables seamless switching of fully heterogeneous loops through the latch-like operator and synchronization loop modifications. Meanwhile, the present disclosure is suitable for various power grid environments, including strong power grids, weak power grids, power grid frequency deviation scenarios, power grid voltage abnormal scenarios and the like.
(2) The present disclosure categorizes control loops of grid-connected converters into the synchronization loop and other loops, thereby clarifying the physical characteristic of each loop to enable more rational mode switching. The synchronization loop generates built-in phase information within the controller, with different synchronization loops representing different interaction modes between the grid-connected converters and the power grid. The other loops are primarily responsible for achieving specific control of each key variable under the premise of completing synchronization with the power grid. The physical meanings of these two loops are fundamentally different, and the separate processing of the two types of loops is one of the factors that makes the present disclosure superior to existing grid-following/grid-forming switching schemes.
(3) In the processing of the synchronization loop, the phase error feedback loop proposed in the present disclosure features a simple structure while delivers significant results. The error caused by phase mutation is eliminated by leveraging the periodicity of the sine function, and a proportional integral (PI) controller of the power synchronization loop is reused, allowing the grid-forming converter to follow output of phase-locked loop of the grid-following control in the grid-following mode. The primary purpose of deactivating the primary frequency regulation loop is to minimize the impact of the switching process, especially in scenarios involving grid frequency deviations. In the grid-forming mode, the original grid-following control loop is fully utilized, allowing the phase-locked loop of the grid-following control to keep operating. Without adding other control loops, the grid-following phase information can track the output of the power synchronization loop in the grid-forming mode without steady-state error.

In the processing of other loops, the present disclosure proposes a general latch-like operator structure, which is similar to the latch concept in digital circuits. The core concept is to utilize the integrator structure of an idle loop in the dual-mode control to synchronize corresponding variables in the operating loop without steady-state error, achieving seamless mode switching. Due to the generality of the latch-like operator, various grid-following and grid-forming controls can be modified and combined according to the proposed method. Moreover, since the latch-like operator primarily utilizes the zero-steady-state-error characteristic of the integrator, it only requires an integrator in the original control loop without imposing requirements on the control object of the loop. Therefore, this operator can be applied to grid-following/grid-forming mode switching without an identical loop, such as mode switching between single-voltage-loop grid-forming control and single-current-loop grid-following control, offering greater flexibility than traditional switching methods.

The technical solutions of the present disclosure will be further described in detail below with reference to drawings and embodiments.

### BRIEF DESCRIPTION OF THE DRAWINGS

FIG. 1 is a flowchart of an embodiment of a method for switching between grid-following and grid-forming control modes for converters based on a latch-like operator according to the present disclosure;

FIG. 2 is a structural diagram of a latch-like operator according to the present disclosure;

FIG. 3 is a schematic diagram of operating state switching between grid-following and grid-forming modes according to an embodiment of the present disclosure;

FIG. 4 is a schematic diagram of a mode switching method of a synchronization loop in grid-following/grid-forming control according to the present disclosure;

FIG. 5 is a schematic diagram of a three-phase two-level renewable energy grid-connected system with an inductor-capacitor (LC) filter according to an embodiment of the present disclosure;

FIG. 6 is a control block diagram of a single-current-loop grid-following control selected in S1 according to an embodiment of the present disclosure;

FIG. 7 is a control block diagram of a single-voltage-loop grid-forming control selected in S1 according to an embodiment of the present disclosure;

FIG. 8 is a system control block diagram of overall control operating in a grid-forming mode after modifying single-current-loop grid-following control and single-voltage-loop grid-forming control according to an embodiment of the present disclosure;

FIG. 9 is a system control block diagram of overall control operating in a grid-following mode after modifying single-current-loop grid-following control and single-voltage-loop grid-forming control according to an embodiment of the present disclosure;

FIG. 10 is a waveform diagram of experimental results of switching from a grid-following mode to a grid-forming mode in a weak power grid (a short circuit ratio of the power grid is 1.9 p.u.) according to an embodiment of the present disclosure;

FIG. 11 is a waveform diagram of experimental results of switching from a grid-forming mode to a grid-following mode in a weak power grid (a short circuit ratio of the power grid is 1.9 p.u.) according to an embodiment of the present disclosure;

FIG. 12 is a waveform diagram of experimental results of switching from a grid-following mode to a grid-forming mode in a strong power grid (a short circuit ratio of the power grid is 12.8 p.u.) according to an embodiment of the present disclosure; and

FIG. 13 is a waveform diagram of experimental results of switching from a grid-forming mode to a grid-following mode in a strong power grid (a short circuit ratio of the power grid is 12.8 p.u.) according to an embodiment of the present disclosure.

### DETAILED DESCRIPTION OF THE EMBODIMENTS

The technical solutions of the present disclosure will be further described below with reference to the drawings and embodiments.

Unless otherwise defined, the technical or scientific terms used herein should have the usual meanings understood by a person of ordinary skill in the field to which the present disclosure belongs. Terms such as "first" and "second" used herein do not denote any order, quantity or importance, but are merely intended to distinguish between different constituents. "Comprising", "containing", and similar words mean that elements or articles appearing before "comprising" or "containing" include the elements or articles and their equivalent elements appearing behind "comprising" or "containing", not excluding any other elements or articles. Terms such as "connected to" and "connected with" are not restricted to physical or mechanical connections, but may also include electrical connections, whether direct or indirect. "Upper", "lower", "left", "right", and the like are used only to indicate a relative positional relationship, and when the absolute position of the described object is changed, the relative positional relationship may also be changed accordingly.

### Embodiment 1

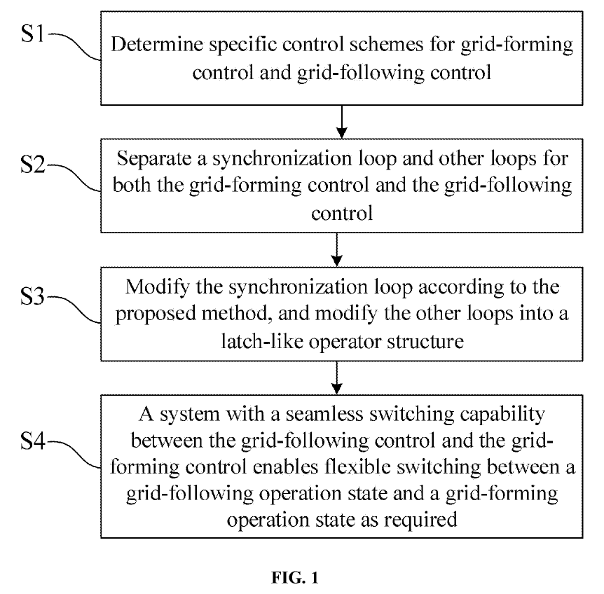

As shown in FIG. 1, the present disclosure provides a method for switching between grid-following and grid-forming control modes of converters based on a latch-like operator, including the following steps:

In S1, specific control schemes are determined for grid-forming control and grid-following control that are intended to achieve mode switching.

The control schemes for the grid-forming control and the grid-following control are separately determined according to system design requirements, and the proposed method is applicable to various mode switching scenarios between the grid-following control and the grid-forming control, including a case in which no identical control loop exists.

In S2, a synchronization loop and other loops are separated for both the grid-forming control and the grid-following control.

The synchronization loop is defined as a loop for generating a phase of a control coordinate system, and is a phase-locked loop in the grid-following control or a power synchronization loop in the grid-forming control; and the other loops are defined as loops exerting control effects on other variables than the synchronization loop.

In S3, the synchronization loop is modified according to the proposed method, and the other loops are modified into a latch-like operator structure.

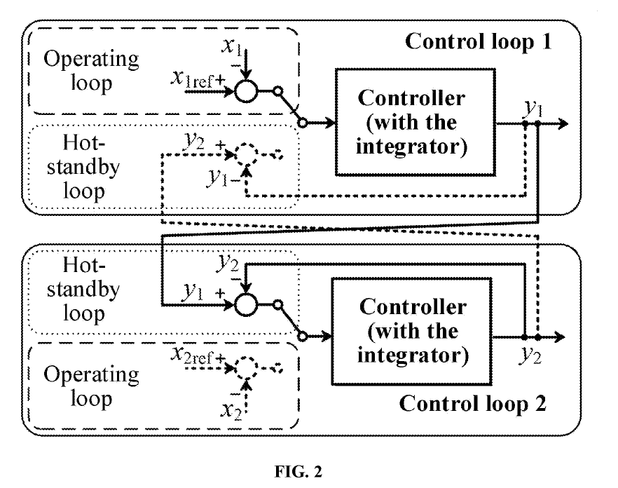

For the modification of the other loops, control loops containing integrators are first selected, operating loops of the control loops remain unchanged, and a hot-standby loop is added to pre-synchronize an integrator output value of a controller when an operating mode of the controller is inactive, to achieve subsequent seamless mode switching, as shown in FIG. 2. A control loop 1 and a control loop 2 are control loops in two different modes according to this embodiment, and a controller with an integrator is selected to form the latch-like operator structure.

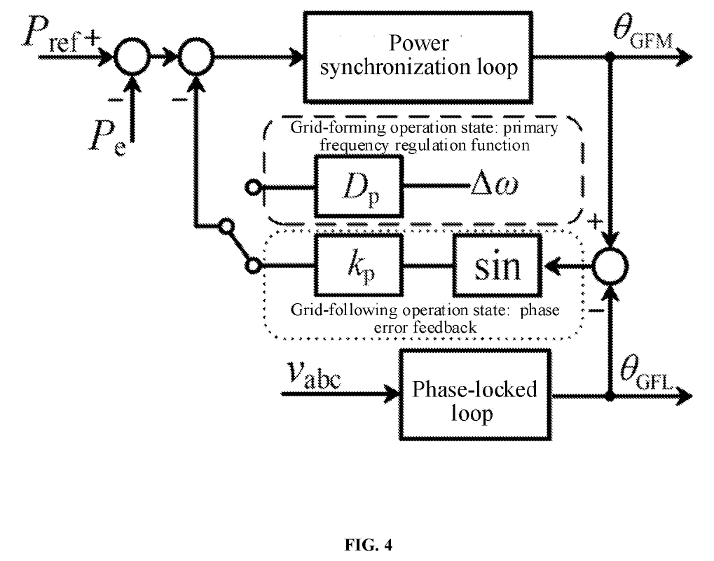

For the modification of the synchronization loop, a primary frequency regulation function of the grid-forming control mode is disabled when the grid-following control mode is enabled, and a phase error feedback loop is added to enable a power synchronization loop of the grid-forming control to track output of a grid-following phase-locked loop without steady-state error in the grid-following operation state. Since the phase is a periodic variable, the sine function is utilized to eliminate potential abrupt changes in periodic phase variations, as shown in FIG. 4.

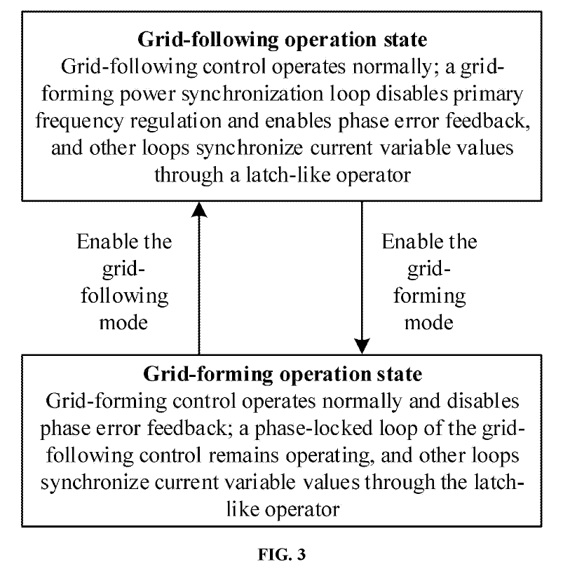

In S4, a system with seamless switching capability between the grid-following control and the grid-forming control enables flexible switching between the grid-following operation state and the grid-forming operation state as required, as shown in FIG. 3.

The system is able to operate in the grid-following operation state or the grid-forming operation state; in the grid-following operation state, all loops of the grid-following control remain active, a grid-forming power synchronization loop disables a primary frequency regulation function and enables a phase error feedback function to track a phase of the grid-following control, the other loops synchronize current variable values through the latch-like operator, for seamless switching to the grid-forming control mode at any time; and in the grid-forming control mode, the grid-forming power synchronization loop disables the phase error feedback function and operates normally, a phase-locked loop of the grid-following control remains operating to track a phase of the grid-forming control without steady-state error, and the other loops synchronize current variable values in real time through the latch-like operator, for seamless switching to the grid-following control mode at any time.

As shown in FIG. 4, in the grid-following mode of this embodiment, the switch is set to the lower position to activate the phase error feedback loop while deactivating the primary frequency regulation function. This enables the grid-forming control loop to track the output phase of the grid-following phase-locked loop in the grid-following mode. In the grid-forming mode, the switch is set to the upper position to deactivate the phase error feedback and activate the primary frequency regulation function, while the grid-following phase-locked loop maintains operation to naturally track the grid-forming phase output.

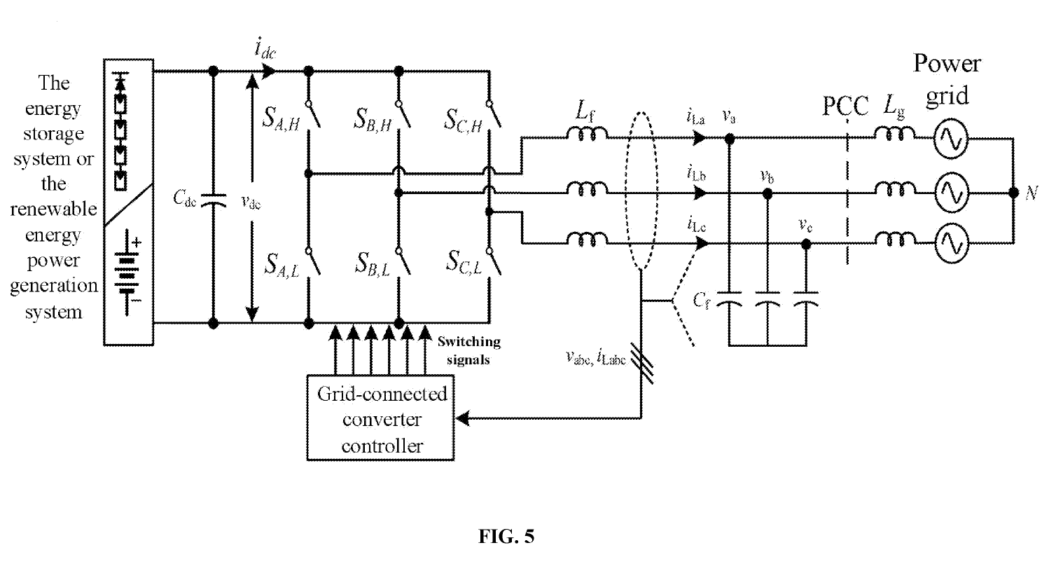

As shown in FIG. 5, this embodiment employs a three-phase two-level renewable energy grid-connected system with LC filters. The direct current side is powered by either a renewable energy system or an energy storage system, and the grid-connected converter controller can be a controller of the grid-following control, the grid-forming control, or the grid-following/grid-forming mode switching control proposed in the present disclosure. In the figure, C dc represents a direct current side capacitor. v dc and i dc represent the direct current side voltage and current respectively. S ABC,H and S ABC,L constitute the three-phase two-level converter controlled by six switch signals from the grid-connected converter controller. L f and C f are the LC filter, v abc and i Labc are the capacitor voltage and inductor current of the three-phase filter respectively, which are sampled and fed into the grid-connected converter controller. PCC stands for the point of common coupling of the converter, and L g represents a grid-side equivalent impedance.

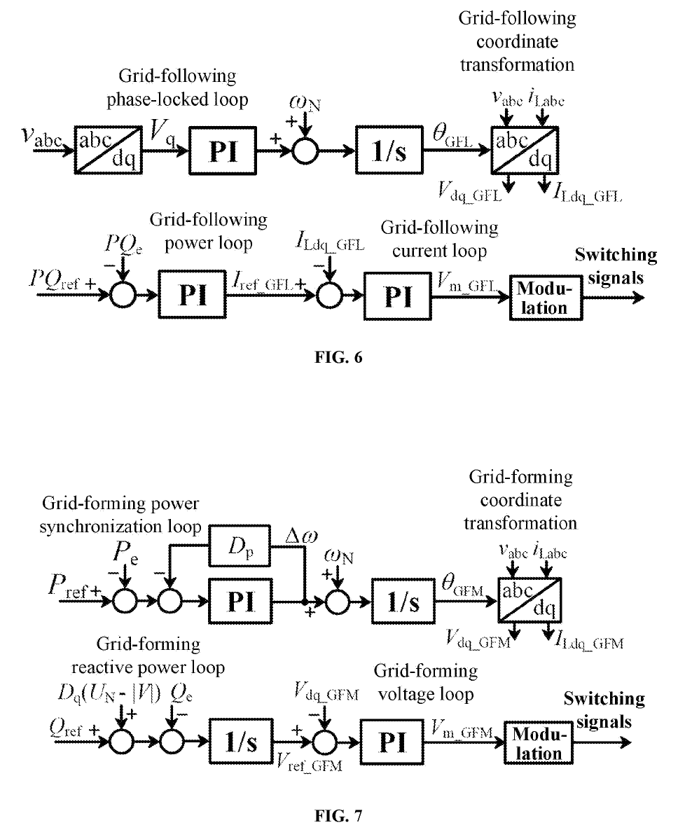

FIG. 6 is a control block diagram of single-current-loop grid-following control selected in S1 in this embodiment. v abc and i Labc represent the sampled capacitor voltage and inductor current of the three-phase filter, respectively. V dq_GFL and I Ldq_GFL represent a dq-axis capacitor voltage and inductor current obtained through coordinate transformation using the phase θ GFL generated by the phase-locked loop of the grid-following control. 1/s indicates the integrator; and ω N represents the grid frequency reference value. PQ ref is the active and reactive power output reference for the converter, while PQ e is the current active and reactive power output of the system, calculated from the capacitor voltage and inductor current. A grid-following power loop obtains a current reference value I ref_GFL via the PI controller, and then obtains a modulation waveform V m_GFL through the PI controller of the current loop, ultimately generating the switch signals through modulation.

FIG. 7 is a control block diagram of single-voltage-loop grid-forming control selected in S1 in this embodiment. v abc and i Labc represent the sampled capacitor voltage and inductor current of the three-phase filter, respectively. V dq_GFL and I Ldq_GFL represent the dq-axis capacitor voltage and inductor current obtained through coordinate transformation using the phase θ GFL generated by the power synchronization loop of the grid-forming control. D p is the droop coefficient of the primary frequency regulation function. PQ ref is the active and reactive power output reference for the converter, while PQ e is the current active and reactive power output of the system, calculated from the capacitor voltage and inductor current. D q represents the reactive power-voltage droop coefficient of the grid-forming reactive power loop. U N represents the nominal grid voltage value, |V| represents the output voltage magnitude, and the reactive power loop obtains a grid-forming voltage reference value V ref_GFM through an integrator. The grid-forming voltage loop obtains a modulation waveform V m_GFM via the PI controller, ultimately generating the switch signals through modulation.

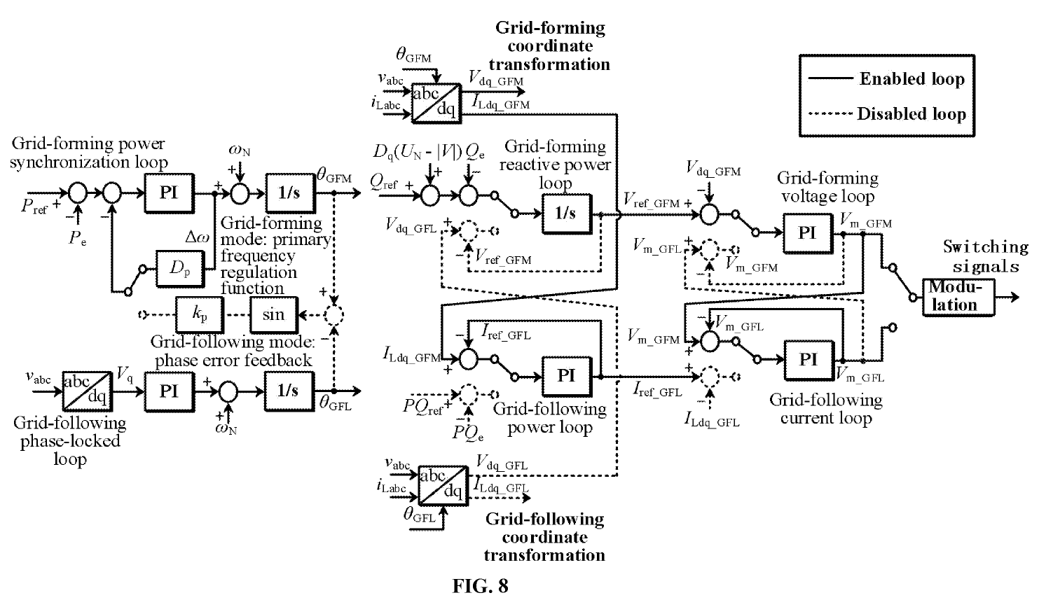

FIG. 8 is a system control block diagram of overall control operating in the grid-forming mode after modifying the single-current-loop grid-following control in FIG. 6 and the single-voltage-loop grid-forming control in FIG. 7 through S1-S3 according to this embodiment. Solid lines represent enabled loops while dashed lines represent disabled loops. All switches are set to the upper position, indicating that the system is in the grid-forming mode. All loops in the original grid-forming mode operate normally, while the PI controllers from the power loop and the current loop of the original grid-following mode operate as hot-standby loops, synchronizing current control variables in real time, to enable seamless switching to the grid-following mode at any time.

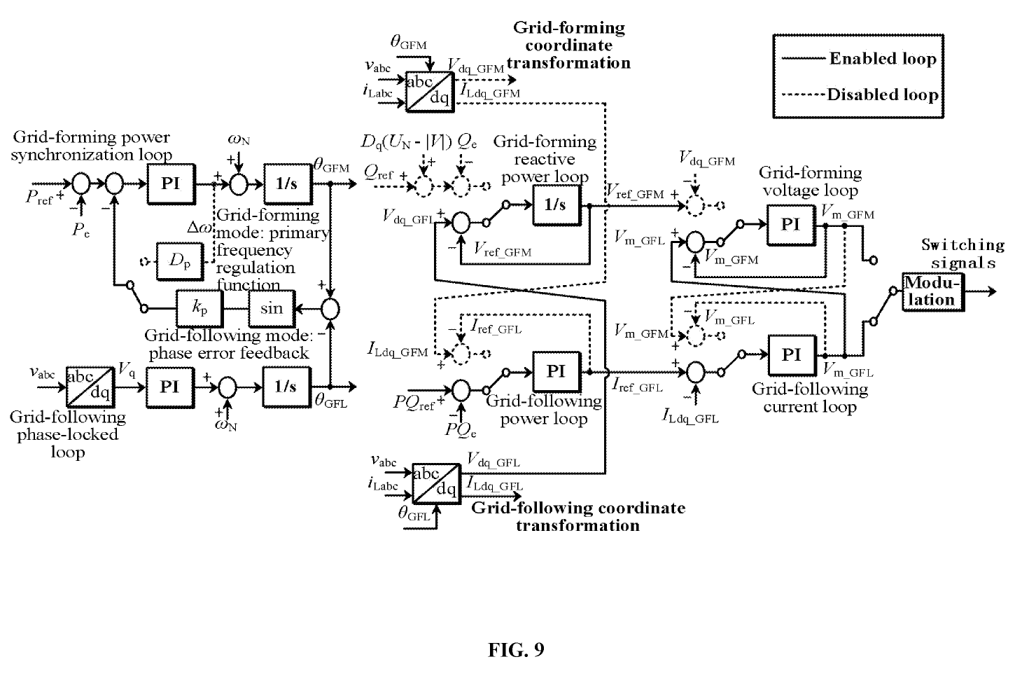

FIG. 9 is a system control block diagram of overall control operating in the grid-following mode after modifying the single-current-loop grid-following control in FIG. 6 and the single-voltage-loop grid-forming control in FIG. 7 through S1-S3 according to this embodiment. Solid lines represent enabled loops while dashed lines represent disabled loops. All switches are set to the lower position, indicating the system is in the grid-following mode. All loops in the original grid-following mode operate normally, while the integrator and PI controller from the reactive power loop and voltage loop of the original grid-forming mode operate as hot-standby loops, synchronizing current control variables in real time, to enable seamless switching to the grid-forming mode at any time.

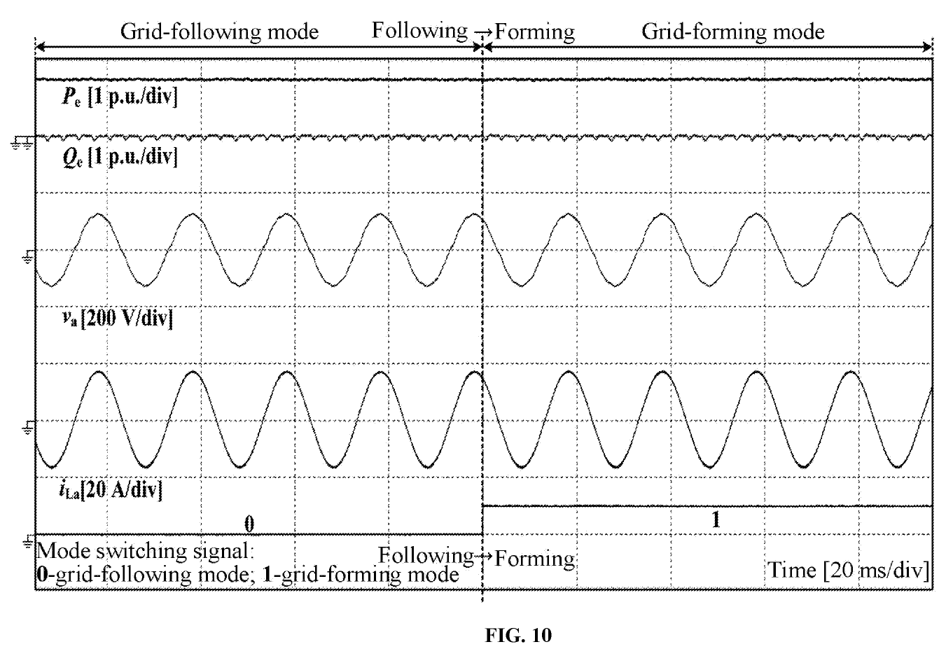

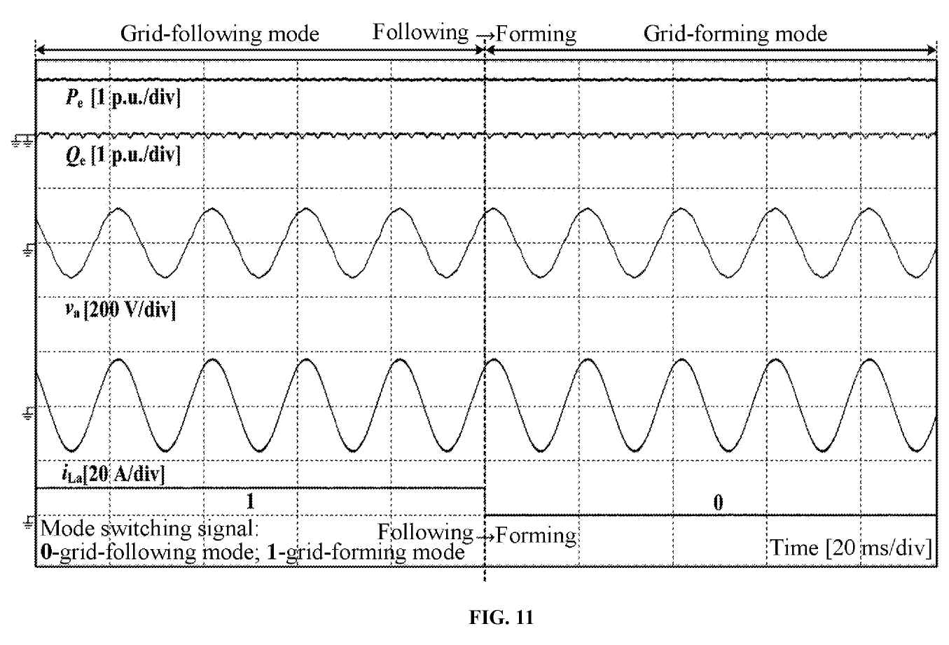

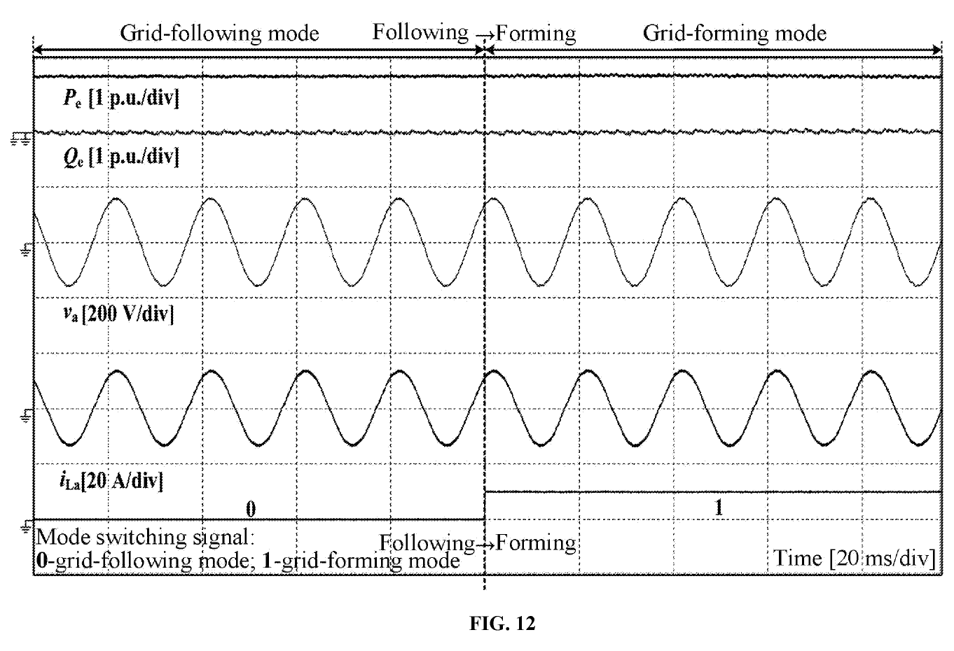

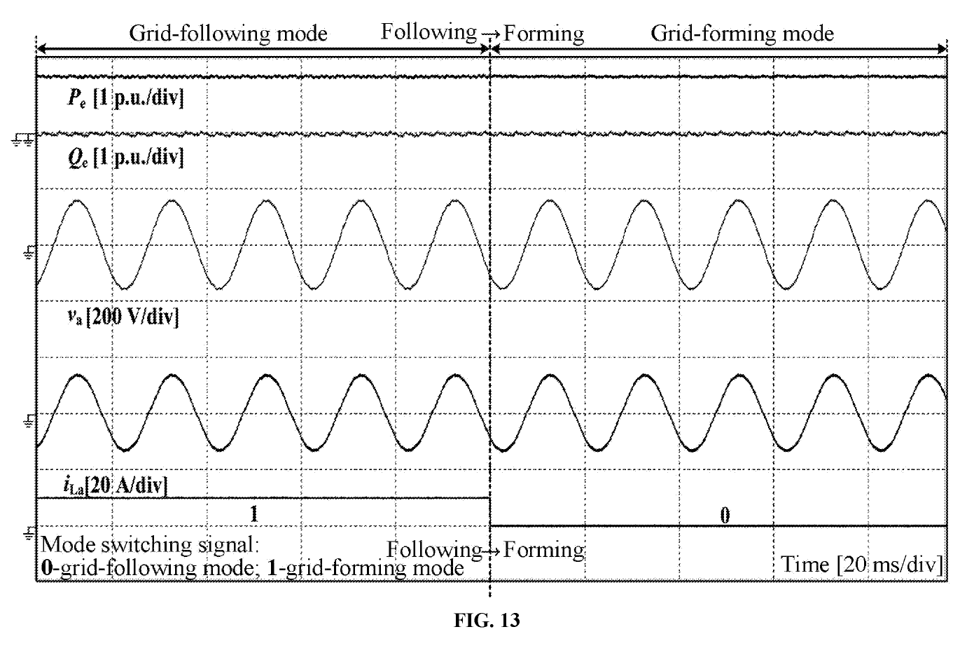

In this example, the waveform of experimental results of switching from the grid-following mode to the grid-forming mode in a weak power grid (a short circuit ratio of the power grid is 1.9 p.u.) is shown in FIG. 10. The waveform of experimental results of switching from the grid-forming mode to the grid-following mode in a weak power grid (a short circuit ratio of the power grid is 1.9 p.u.) is shown in FIG. 11. The waveform of experimental results of switching from the grid-following mode to the grid-forming mode in a strong power grid (a short circuit ratio of the power grid is 12.8 p.u.) is shown in FIG. 12. The waveform of experimental results of switching from the grid-forming mode to the grid-following mode in a strong power grid (a short circuit ratio of the power grid is 12.8 p.u.) is shown in FIG. 13.

Therefore, the present application adopts the method for switching between grid-following and grid-forming control modes of converters based on a latch-like operator, to resolve the problem of switching between the grid-following control mode and the grid-forming control mode without an identical control loop.

Finally, it should be noted that the foregoing embodiments are only intended to describe, rather than to limit the technical solutions of the present disclosure. Although the present disclosure is described in detail with reference to the preferred embodiments, a person of ordinary skill in the art should understand that modifications or equivalent replacements may be made to the technical solutions of the present disclosure without departing from the spirit and scope of the technical solutions of the present disclosure.

What is claimed is:

1. A method for switching between grid-following and grid-forming control modes of converters based on a latch-like operator, the method comprising the following steps:
S1: determining specific control schemes for grid-forming control and grid-following control that are intended to achieve mode switching;
S2: separating a synchronization loop and other loops for both the grid-forming control and the grid-following control;
S3: modifying the synchronization loop according to a proposed method, and modifying the other loops into a latch-like operator structure; and
S4: enabling, by a system with a seamless switching capability between the grid-following control and the grid-forming control, flexible switching between a grid-following operation state and a grid-forming operation state as required.

2. The method for switching between grid-following and grid-forming control modes of converters based on a latch-like operator according to claim 1, wherein in S1, the control schemes for the grid-forming control and the grid-following control are separately determined according to system design requirements, and the proposed method is applicable to various mode switching scenarios between the grid-following control and the grid-forming control, comprising a case in which no identical control loop exists.

3. The method for switching between grid-following and grid-forming control modes of converters based on a latch-like operator according to claim 1, wherein in S2, the synchronization loop is defined as a loop for generating a phase of a control coordinate system, and is a phase-locked loop in the grid-following control or a power synchronization loop in the grid-forming control; and the other loops are defined as loops exerting control effects on other variables than the synchronization loop.

4. The method for switching between grid-following and grid-forming control modes of converters based on a latch-like operator according to claim 1, wherein in S3, for the modification of the other loops, control loops containing integrators are first selected, operating loops of the control loops remain unchanged, and a hot-standby loop is added to pre-synchronize an output value of a controller when an operating mode of the controller is inactive, to achieve subsequent seamless mode switching.

5. The method for switching between grid-following and grid-forming control modes of converters based on a latch-like operator according to claim 1, wherein in S3, for the modification of the synchronization loop, a primary frequency regulation function of the grid-forming control mode is disabled when the grid-following control mode is enabled, and a phase error feedback loop is added to enable a power synchronization loop of the grid-forming control to track output of a grid-following phase-locked loop without steady-state error in the grid-following operation state.

6. The method for switching between grid-following and grid-forming control modes of converters based on a latch-like operator according to claim 1, wherein in S4, the system is able to operate in the grid-following operation state or the grid-forming operation state; in the grid-following operation state, all loops of the grid-following control remain active, a grid-forming power synchronization loop disables a primary frequency regulation function and enables a phase error feedback function to track a phase of the grid-following control, the other loops synchronize current variable values through the latch-like operator, for seamless switching to the grid-forming control mode at any time; and in the grid-forming control mode, the grid-forming power synchronization loop disables the phase error feedback function and operates normally, a phase-locked loop of the grid-following control remains operating to track a phase of the grid-forming control without steady-state error, and the other loops synchronize current variable values in real time through the latch-like operator, for seamless switching to the grid-following control mode at any time.
